(19) United States
(12) Patent Application Publication
(10) Pub. No.: US 2005/0036637 A1
(43) Pub. Date: Feb. 17, 2005

(54) Automatic adjusting hearing aid

(75) Inventor: Franciscus Hubertus Janssen, Waalre (NL)

Correspondence Address: David G. Beck;Bingham McCutchen LLP, 18th Floor, Three Embarcadero Center, San Francisco, CA, 94111, US

(73) Assignee: Beltone Netherlands B.V.

(21) Appl. No.: 10/843,012

(22) Filed: May 11, 2004

Related U.S. Application Data
(63) Continuation of application No. 10/069,515, filed on Jul. 2, 2002, now abandoned.

(30) Foreign Application Priority Data
Sep. 2, 1999 (EP) 99202848.0

(51) Int. Cl. H04R 25/00

(52) U.S. Cl. 381/315; 381/313; 381/312; 381/317

(57) ABSTRACT

A hearing aid that stores preset signal processing parameters, and performs stepwise adjustment of one or more of the stored signal processing parameters from a starting point of a predetermined range to an end point of the range is provided. Examples of signal processing parameters to be adjusted are high tone amplification, maximum output level and noise suppression threshold value. Examples of trigger signal supplying means include a time clock, the power state of the hearing aid, battery replacement, and a switch. The hearing aid may be arranged for mutual communication with an external unit. The external unit may select the one or more parameters to be adjusted, set the range of the one or more parameters to be adjusted, set a step magnitude to be used in the stepwise adjustment, and set the repeat interval of the successive trigger signals in the time clock. The hearing aid carries out the adjustment autonomously.

### PRIORTY CLAIM

The present application is a continuation of U.S. patent application Ser. No. 10/069,515, filed Jul. 2, 2002, which is a 371 of PCT/NL00/00571, filed Aug. 14, 2000, which claims priority from EP 99202848.0, filed Sep. 2, 1999.

### BACKGROUND OF THE INVENTION

When an audiologist or other adjuster sets-up a hearing aid, typically the adjustment is aimed at maximizing speech audibility. The settings determine the manner in which ambient sound picked-up by the transducer is processed, for example amplified, filtered, or otherwise processed, thereby adapting the hearing aid to the hearing loss of the person in question. If the person for which the hearing aid is intended has been unable to hear certain frequencies, levels, sound pressures or some combination thereof for an extended period of time, for example years, they may find the use of a properly adjusted hearing aid to be an unpleasant experience. For example, if the person has been unable to hear high tones for several years, upon initial fitting the person may find the sound emanating from the hearing aid to be especially shrill.

As many people who have been hard of hearing for a long time find it difficult to immediately acclimate to a properly adjusted hearing aid, often times the adjuster will not optimize the hearing aid during the initial adjustment. Otherwise there is a good chance that the person who is hard of hearing will not use their hearing aid due to the perceived unpleasant output from the aid. Of course if the hearing aid is not sufficiently optimized, the user may find that speech audibility has not been sufficiently improved to warrant the use of the hearing aid.

A common approach to overcoming the afore-mentioned problems is to gradually adjust the performance of the hearing aid over the course of several office visits. This allows the user to gradually become accustomed to the improved hearing offered by the hearing aid. Normally, the number of repeat visits will be relatively small, and consequently the adjustment steps must be relatively large. Of course if the adjustment steps are too large, there is a possibility that the person who is hard of hearing will prefer the previous, less optimal settings, requesting that the adjuster use the previous settings.

The problem of acclimatization may occur regardless of the type of hearing impairment (e.g., tone, level, sound pressure). For example, if the hearing impaired person has been unable to hear low level sounds for years, the sudden ability to hear such sounds (e.g., ticking clocks, background noise from traffic or electrical equipment, etc.) may be quite objectionable. This may be true in spite of the fact that soft sounds often contain valuable information. As a result the adjuster may set a relatively high noise suppression threshold value (i.e., the point at which sound levels are amplified) at the first fitting.

Accordingly, what is needed in the art is a means for gradually and automatically adjusting the operational parameters of a hearing aid. The present invention provides such a means.

### SUMMARY OF THE INVENTION

An object of the invention is to provide a hearing aid that automatically adjusts itself in time. In order to accomplish that objective the hearing aid of the invention is comprised of a first means for processing signals from a transducer, a second means linked to the first means for storing one or more signal processing parameters, a third means linked to the second means for stepwise adjusting within a predetermined range the one or more signal processing parameters stored in the second means in response to successive trigger signals. The objective may further be accomplished with the inclusion of a fourth means for selecting and setting in the third means the one or more parameters to be adjusted. The objective may further be accomplished with the inclusion of a fifth means for setting in the third means the range of the one or more parameters to be adjusted. The objective may further be accomplished with the inclusion of a sixth means for setting in the third means the magnitude of the steps to be used in the stepwise adjustment. If the hearing aid includes a time clock, the objective may further be accomplished with the inclusion of a seventh means for setting of the repeat interval of the successive trigger signals provided by the time clock.

According to one aspect of the invention, the hearing aid automatically adjusts itself in time irrespective of whether the trigger signals are generated manually or automatically. Although the difference between the initial parameter settings and the final parameter settings are audible, preferably the steps of the stepwise adjustment are sufficiently small to make the differences between steps almost inaudible.

Preferably the starting point of a parameter range is defined by an initial setting that is acceptable to the intended user of the hearing aid albeit less than optimal while the final point of the parameter range is defined by the optimal setting for the intended user. The initial setting and the final setting are pre-set, i.e., pre-programmed, by the adjuster. The time that is required for going from the initial setting to the final setting is the habituation period. A habituation period may be days, weeks, or in some cases, months. In one aspect of the invention, the habituation period is pre-set, i.e., pre-programmed, by the adjuster. In another aspect of the invention, the magnitude of the steps during the habituation period is pre-set, i.e., pre-programmed, by the adjuster.

The automatic, stepwise adjustment of the invention can be performed in any of a variety of ways. For example, a clock can be incorporated into the hearing aid, the hearing aid making stepwise adjustments in accordance with a predetermined period of time provided by the clock. Alternately, the steps of the stepwise adjustment can occur each time the hearing aid is turned off and then on again (or after a pre-set number of off/on periods). Alternately, the steps of the stepwise adjustment can occur each time the battery is replaced (or after a pre-set number of battery replacements). Alternately, the steps of the stepwise adjustment can occur each time a switch or knob is operated (or after a pre-set number of switch/knob operations). It will be appreciated that depending upon the trigger mechanism, the hearing aid may further be comprised of a clock, switch, knob, battery replacement detector, or a detector for monitoring the power state (i.e., on or off) of the hearing aid.

In another aspect of the invention, the fourth means may be contained in an external unit in communication with the hearing aid. In another aspect of the invention, the fifth means may be contained in an external unit in communication with the hearing aid. In another aspect of the invention, the sixth means may be contained in an external unit in communication with the hearing aid.

One of the benefits of the present invention is that at the first fitting, a person who is hard of hearing will receive a hearing aid which sounds acceptable and pleasant. Then during the habituation period, the hearing aid will automatically adjust its performance such that by the end of the habituation period optimal performance is achieved, this level of performance being achieved without the user having to go through a period of unacceptable or unpleasant sound, or having to make repeated visits to an adjuster.

A further understanding of the nature and advantages of the present invention can be realized by reference to the remaining portions of the specification and the drawings.

### BRIEF DESCRIPTION OF THE DRAWING

FIG. 1 is a schematic illustration of an embodiment of the invention.

### DESCRIPTION OF THE SPECIFIC EMBODIMENTS

Hearing aid 1 comprises at least one first transducer 2 (e.g., a microphone) for converting sound into an electric signal, at least one second transducer 3 (e.g., a loudspeaker) for converting an electric signal into sound, a first means 4 for processing and amplifying an electric signal from the at least one first transducer 2 and supplying the processed and amplified electric signal to the at least one second transducer 3, a second means 5 (e.g., memory) linked to the first means 4 for storing signal processing parameters, and a third means linked to the second means 5 for stepwise adjusting one or more signal processing parameters of the second means 5 from a starting point of a predetermined range to an end point of the predetermined range in response to successive trigger signals 7.

In at least one embodiment of hearing aid 1, the starting point of the predetermined range of one or more processing parameters is defined by an initial setting that is acceptable to an intended user of the hearing aid, wherein the performance (e.g., amplification of specific tones, sound levels, sound pressures; noise suppression threshold value; maximum output level, etc.) is less than optimal and consequently the audibility as regards to speech is less than optimal. The ending point of the predetermined range of the one or more processing parameters is defined by a final setting that is optimal for the intended user, wherein the performance (e.g., amplification of specific tones, sound levels, sound pressures; noise suppression threshold value; maximum output level, etc.) is optimal and consequently the audibility as regards to speech is optimal.

In at least one embodiment of the invention, first means 4, second means 5, and/or third means 6 form part of one or more integrated circuits.

In at least one embodiment of the invention, hearing aid 1 includes a time clock 8 for supplying the successive trigger signals 7. In at least one embodiment of the invention, hearing aid 1 includes an eighth means 9 for supplying the successive trigger signals 7 in response to repeated turning on of hearing aid 1. In at least one embodiment of the invention, hearing aid 1 includes a ninth means 10 for detecting the placing of a battery in hearing aid 1, ninth means 10 supplying the successive trigger signals 7 in response to the repeated replacement of the battery. In at least one embodiment of the invention, hearing aid 1 includes a switching means 11 (e.g., knob) for supplying the successive trigger signals 7 in response to repeated operation of means 11.

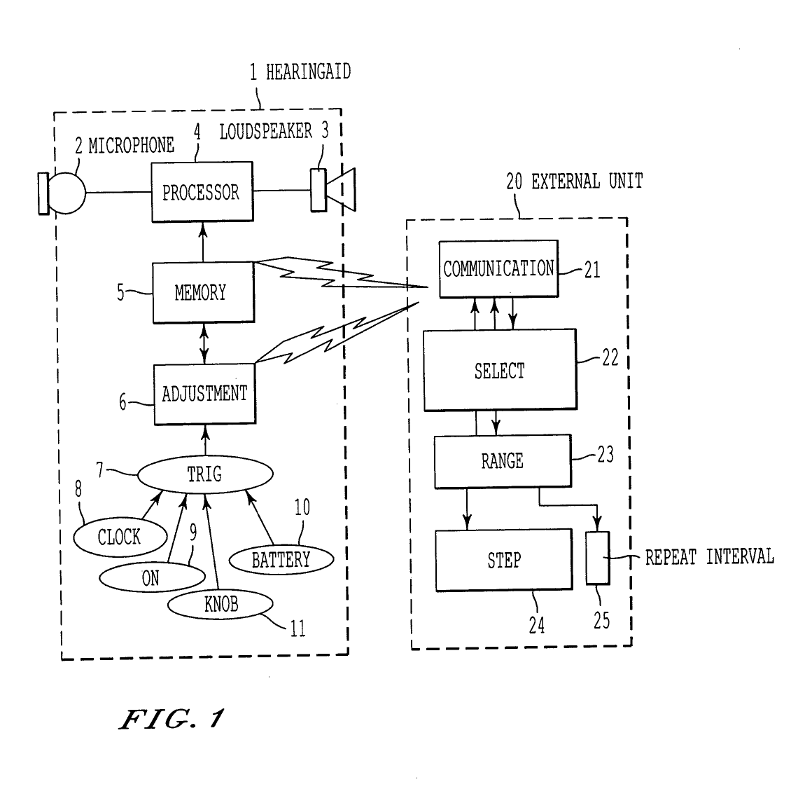

Although FIG. 1 illustrates the inclusion of clock means 8, eighth means 9, ninth means 10, and switching means 11, it will be understood that hearing aid 1 will typically include less than all of these means, and will more typically include only one of these means. It will be appreciated by a person of average skill in the art how to incorporate clock means 8, eighth means 9, ninth means 10 and/or switch means 11 into the aforesaid one or more integrated circuits, such that the successive trigger signals 7 will be supplied. Accordingly further discussion of these features is not included herein. It will also be appreciated that other means for providing the desired successive trigger signals are possible.

In at least one embodiment of the invention, hearing aid 1 includes a fourth means (not shown) for selecting and setting in third means 6 the one or more parameters to be adjusted. In at least one embodiment of the invention, hearing aid 1 includes a fifth means (not shown) for setting in third means 6 the range of the one or more parameters to be adjusted. In at least one embodiment of the invention, hearing aid 1 includes a sixth means (not shown) for setting in the third means 6 the magnitude of the steps to be used in the stepwise adjustment. Further, in the embodiment in which hearing aid 1 includes clock means 8, a seventh means (not shown) is included for setting the repeat interval of the successive trigger signals 7 in clock means 8.

In the preferred embodiment, however, the fourth through seventh means are incorporated in an external unit 20, whereby the third means 6, and preferably the second means 5 as well, are adapted to communicate with a communication means 21 of external unit 20. In this embodiment, preferably fourth means 22, fifth means 23, sixth means 24 and seventh means 25 are comprised of a software program operating on a PC or other external processor/computer.

As will be understood by those familiar with the art, the present invention can be embodied in other specific forms without departing from the spirit or essential characteristics thereof. Accordingly, the disclosures and descriptions herein are intended. to be illustrative, but not limiting, of the scope of the invention which is set forth in the following claims.

1. A hearing aid comprising:
at least one first transducer for converting sound into an electric signal;
at least one second transducer for converting an electric signal into sound;
first means for processing and amplifying an electric signal from said first transducer and supplying said processed and amplified electric signal to said second transducer;
second means linked to said first means for storing signal processing parameters; and
third means linked to said second means for the stepwise adjustment from a starting point of a predetermined range to an end point of said range of one or more signal processing parameters from said second means in response to successive trigger signals, wherein said third means are arranged for communication with an external unit that comprises fourth means for selecting and setting in said third means one or more parameters to be adjusted, fifth means for setting in said third means said range of said one or more parameters to be adjusted, and sixth means for setting in said third means a magnitude of steps to be used in said stepwise adjustment, wherein said stepwise adjustment in response to the successive trigger signals occurs automatically as an operation of said hearing aid.

2. A hearing aid comprising:
at least one first transducer for converting sound into an electric signal;
at least one second transducer for converting an electric signal into sound;
first means for processing and amplifying an electric signal from said first transducer and supplying said processed and amplified electric signal to said second transducer;
second means linked to said first means for storing signal processing parameters;
third means linked to said second means for the stepwise adjustment from a starting point of a predetermined range to an end point of said range of one or more signal processing parameters from said second means in response to successive trigger signals, wherein said stepwise adjustment in response to the successive trigger signals occurs automatically as an operation of said hearing aid; and
a time clock for supplying said successive trigger signals, wherein said third means are arranged for communication with an external unit that comprises fourth means for setting a repeat interval of said successive trigger signals in said time clock.

3. An external unit arranged for communication with a hearing aid, said hearing aid comprising:
at least one first transducer for converting sound into an electric signal,
at least one second transducer for converting an electric signal into sound,
first means for processing and amplifying an electric signal from said first transducer and supplying said processed and amplified electric signal to said second transducer,
second means linked to said first means for storing signal processing parameters, and
third means linked to said second means for stepwise adjustment from a starting point of a predetermined range to an end point of said range of one or more signal processing parameters from said second means in response to successive trigger signals,
wherein said external unit is arranged for communication with said third means of said hearing aid and comprises:
fourth means for selecting and setting in said third means one or more parameters to be adjusted, fifth means for setting in said third means said range of said one or more parameters to be adjusted, and
sixth means for setting in said third means a magnitude of steps to be used in said stepwise adjustment, and
wherein said stepwise adjustment in response to the successive trigger signals occurs automatically as an operation of said hearing aid.

4. An external unit arranged for communication with a hearing aid, said hearing aid comprising:
at least one first transducer for converting sound into an electric signal,
at least one second transducer for converting an electric signal into sound,
first means for processing and amplifying an electric signal from said first transducer and supplying said processed and amplified electric signal to said second transducer,
second means linked to said first means for storing signal processing parameters, and
third means linked to said second means for stepwise adjustment from a starting point of a predetermined range to an end point of said range of one or more signal processing parameters from said second means in response to successive trigger signals, and
time clock means for applying said successive trigger signals,
wherein said external unit is arranged for communication with said third means of said hearing aid and comprises:
fourth means for selecting and setting in said third means one or more parameters to be adjusted,
fifth means for setting in said third means said range of said one or more parameters to be adjusted, and
sixth means for setting in said third means a magnitude of steps to be used in said stepwise adjustment, and seventh means for setting a repeat interval of said successive trigger signals in said time clock, and
wherein said stepwise adjustment in response to the successive trigger signals occurs automatically as an operation of said hearing aid.

5. A hearing aid comprising:
at least one first transducer for converting sound into an electric signal;
first means for processing and amplifying said electric signal from said at least one first transducer in accordance with at least one signal processing parameter;
at least one second transducer for converting said processed and amplified electric signal into sound, said first means supplying said processed and amplified electric signal to said second transducer;
second means linked to said first means for storing said at least one signal processing parameter; and
third means responsive to a plurality of successive trigger signals, wherein said third means is linked to said second means, wherein said third means adjusts said at least one signal processing parameter within a predetermined range, and wherein said third means adjusts said at least one signal processing parameter in a stepwise manner; and
automatic trigger means linked to said third means, wherein said automatic trigger means automatically produces said plurality of successive trigger signals.

6. The hearing aid of claim 5, further comprising fourth means linked to said third means for selecting said at least one signal processing parameter.

7. The hearing aid of claim 6, further comprising:
an external unit separate from said hearing aid, wherein said fourth means is included within said external unit; and
communication means within said external unit, said communication means communicating information from said external unit to said hearing aid.

8. The hearing aid of claim 5, further comprising fourth means linked to said third means for selecting said predetermined range.

9. The hearing aid of claim 8, further comprising:
an external unit separate from said hearing aid, wherein said fourth means is included within said external unit; and
communication means within said external unit, said communication means communicating information from said external unit to said hearing aid.

10. The hearing aid of claim 5, wherein said stepwise adjustment is performed in a series of steps, wherein said hearing aid further comprises a fourth means linked to said third means for selecting a magnitude corresponding to each step of said series of steps.

11. The hearing aid of claim 10, further comprising:
an external unit separate from said hearing aid, wherein said fourth means is included within said external unit; and
communication means within said external unit, said communication means communicating information from said external unit to said hearing aid.

12. The hearing aid of claim 5, wherein said predetermined range comprises an initial setting and a final setting, wherein said initial setting provides acceptable performance, and wherein said final setting provides optimal performance.

13. The hearing aid of claim 5, wherein said automatic trigger means further comprises a clock.

14. The hearing aid of claim 5, wherein said automatic trigger means further comprises a detector for monitoring a power state corresponding to the hearing aid, wherein said plurality of successive trigger signals correspond to the detected power state.

15. The hearing aid of claim 5, wherein said automatic trigger means further comprises a battery inclusion detector.

16. The hearing aid of claim 5, wherein said at least one signal processing parameter is selected from the group of parameters consisting of tone amplification, sound level amplification, sound pressure amplification, noise suppression threshold values, and maximum output levels.
